(19) United States
(12) Patent Application Publication
(10) Pub. No.: US 2009/0192703 A1
(43) Pub. Date: Jul. 30, 2009

(54) Method and device for providing information about points of interest using a navigation system

(76) Inventors: Steffen Hess, Sachsenheim (DE); Wolfgang Baierl, Remshalden (DE)

Correspondence Address: KENYON & KENYON LLP, ONE BROADWAY, NEW YORK, NY, 10004, US

(21) Appl. No.: 12/290,578

(22) Filed: Oct. 31, 2008

(30) Foreign Application Priority Data
Nov. 22, 2007 (DE) 10 2007 056 328.2

(51) Int. Cl. G01C 21/00; G09G 5/00

(52) U.S. Cl. 701/200; 345/184

(57) ABSTRACT

A method for defining a geographic area in a map detail for use in a navigation device includes: selecting an area shape; positioning the selected area shape on the map detail at a desired position; and performing a function of the navigation device as a function of a geographic area specified by the area shape positioned on the map detail.

### BACKGROUND OF THE INVENTION

1. Field of the Invention

The present invention generally relates to a navigation system in which, in addition to route information, points of interest (POIs) may also be indicated.

2. Description of Related Art

Navigation systems typically use further information about POIs in addition to the map information required for navigation. The user has the option of displaying POIs of a specific category which are then usually shown as a function of the distance to the current position of the user or to locations along an ascertained travel route in the navigation map.

It is often desirable for a user to only have specific functions of the navigation system, such as route planning or the display of information about specific POIs, performed in a specific geographical area freely defined by the user. Typical navigation systems only allow the display of POIs in a predefined or specifiable vicinity around the position or in a corridor along an ascertained travel route, however. Display of the available POIs in a freely selectable geographic area outside the corridor or in an area outside the position of the user has not been provided until now.

In navigation systems having a small memory capacity, such as that disclosed in international patent publication WO 01/98734 A1, methods are known, via which a geographic area (corridor) is defined around an ascertained route. The size of the corridor is predefined or may be automatically changed as a function of specific parameters during operation. The definition of the corridor allows only the map information which is required for the representation and route guiding along the previously ascertained route to be stored in an internal memory of the navigation device.

It is therefore an object of the present invention to provide a method and a device, via which a geographic area may be defined easily in a navigation system and, in addition, flexible output of POIs to a user is possible.

### BRIEF SUMMARY OF THE INVENTION

According to the present invention, a method for defining a geographic area in a map detail for use in a navigation device is provided. The method includes the selection of an area shape, the positioning of the selected area shape on the map detail at a desired position, and the performance of a function of the navigation device as a function of a geographic area determined by the area shape positioned on the map detail.

The above method has the advantage that the user may select an arbitrary geographic area easily, in which POIs may be output to the user. The geographic area determined by the user is independent of the position of the user and his selected travel route.

Furthermore, the selected area shape may be selected from multiple area shape options, in particular a rectangular area, an elliptical area, and a polygonal area.

According to one example embodiment, the area shape positioned on the map detail may be changed, in particular compressed, rotated, pivoted, or distorted.

Furthermore, at least one of the three following steps may be performed by operating a turn-press controller:
selecting the area shape,
positioning the selected area shape, and/or
changing the area shape.

Alternatively or additionally, at least one of the cited three steps may be performed by operating a touch-sensitive display screen of the navigation device, the operation being performed by tapping a specific position on the display screen and/or by tapping and drawing along a surface of the display screen.

According to one example embodiment, one or more category symbols may be displayed for selecting categories of a point of interest displayable on the map detail, points of interest to be displayed being ascertained as the function depending on the positioned area shape and depending on at least one selected category, and a symbol being displayed to indicate the point of interest to be displayed on the map detail at a position defined by the position information assigned to the point of interest.

Alternatively or additionally, a route ascertainment may be performed as the function, a route exclusively or preferably either being ascertained in the geographic area defined by the positioned area shape or outside thereof in the route ascertainment.

According to a further aspect of the present invention, a navigation device is provided for defining a geographic area in a map detail. The navigation device includes an output unit for outputting a map detail, an input unit for performing an input into the navigation device, a data memory for storing map information, and a processing unit, which is designed so that an area shape is selectable via the input unit, so that the selected area shape is positionable on the map detail at a desired position with the aid of the input unit, and so that a function may be executed depending on a geographic area determined by the area shape positioned on the map detail.

Furthermore, the data memory may be designed to also store POI information about points of interest, the processing unit being designed to display one or more category symbols on the output unit for selecting categories of a point of interest displayable on the map detail, as the function, depending on the positioned area shape and depending on at least one selected category, to ascertain points of interest and to display a symbol to represent the point of interest to be displayed on the map detail at a position defined by the position information assigned to the point of interest.

According to a further aspect of the present invention, a computer program is provided which contains a program code which, when it is executed on a data processing unit, executes the method described above.

### BRIEF DESCRIPTION OF THE SEVERAL VIEWS OF THE DRAWING

FIG. 1 shows a schematic illustration of a navigation device according to an example embodiment of the present invention.

FIG. 2 shows an illustration of a user interface for selecting the geographic area and for selecting the type of POIs according to an example embodiment.

FIG. 3 shows a further illustration of a user interface for selecting the geographic area and for selecting the type of POIs according to another example embodiment.

### DETAILED DESCRIPTION OF THE INVENTION

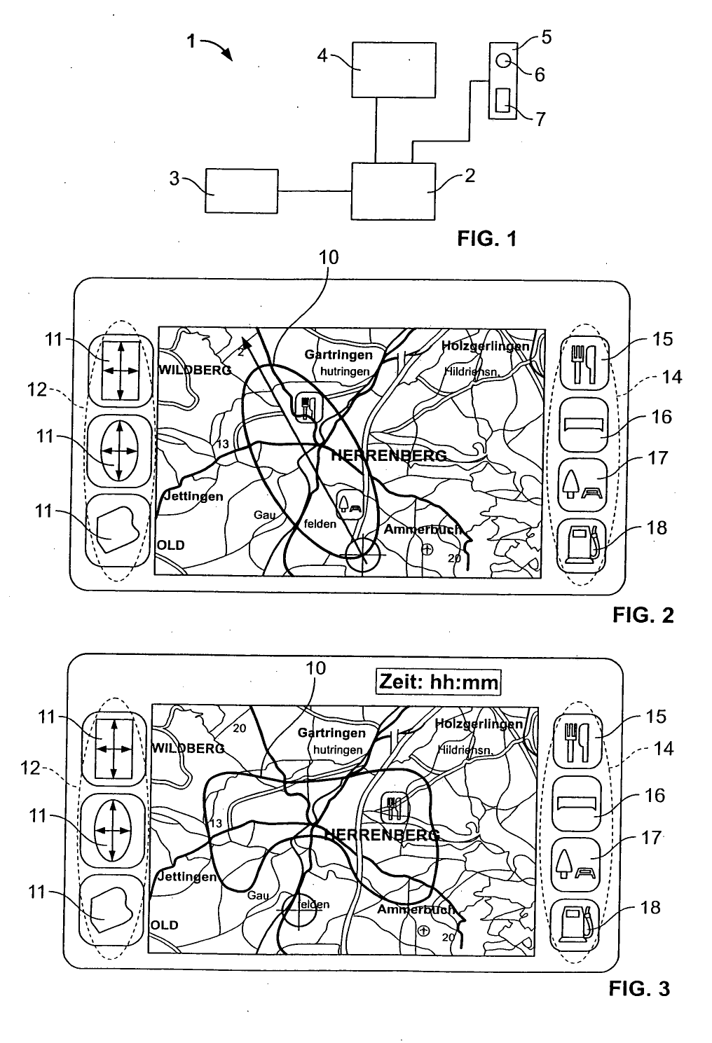

FIG. 1 shows a schematic illustration of a navigation device 1 according to an embodiment of the present invention. Navigation device 1 includes a processing unit 2, which may communicate with a data memory 3 to retrieve data. Map information about geographic data, route information, and information about points of interest as POI information is stored in data memory 3. The POI information includes specifications about the type of point of interest, position data about the geographic position of the point of interest, and specifications, via which the points of interest are selectable according to a classification.

Processing unit 2 is connected to an output unit 4. Output unit 4 includes, for example, a display screen, on which a geographic map may be displayed according to the map information stored in data memory 3. In addition, depending on the selection by a user, the point of interest specified by the POI information may be displayed at a corresponding position on the shown map section defined by the position data assigned to the point of interest.

Processing unit 2 is also connected to an input unit 5, which has one or more operating elements, such as one or more turn-press controller 6, an input button 7, and the like.

According to a further example embodiment, output unit 4 and input unit 5 are designed in the form of a touch-sensitive display screen (touchscreen), so that input into the navigation device may be performed by touching the display screen at a suitable position and/or by drawing a finger along the surface of the display screen.

Processing unit 2 is essentially designed in such a way that it may execute the main functions of a navigation device, such as a route calculation and a destination guide. For the destination guide, processing unit 2 may also be connected to a location recognition detector, such as a GPS receiver. In addition, processing unit 2 is designed to generate output information from the map information, which may be displayed on output unit 4 as a map detail, which virtually images a geographic area. By using the operating elements of input unit 5, this map detail may be zoomed in, zoomed out, horizontally and vertically shifted, and the like in a suitable way in a selection mode. The selection mode may be ended by pressing the input button.

If a touchscreen is used as a combined input/output unit, in the selection mode, the map detail may be shifted by drawing the finger along the display screen surface and may be enlarged or shrunk by drawing the finger along a zoom strip, which is shown in a specific section of the display screen.

The POI information stored in data memory 3 is also provided in each case with position and classification information. In this way, points of interest may be output corresponding to a selection by the user by suitable symbols depending on the classification information on the map detail which is shown on output unit 4.

The selection of a geographic area by the user is performed by defining an area 10, in which (or outside of which) the points of interest are to be shown according to the POI information. A first specific embodiment of the method is explained on the basis of FIG. 2. A selection of multiple different predetermined area shapes 11 is displayed to the user with the aid of output unit 4 in a left section 12 of the display screen of output unit 4. The user may select a rectangular area, an ellipsoidal area, or a polygonal area as area shape 11 with the aid of an operating element, such as the turn-press controller. The outline of geographic area 10 to be defined is shown on the map detail by a selection of corresponding area shape 11. The representation of area 10 to be defined on the map detail is performed by displaying an outline, a partially transparent colored raised area, or a shaded flat area.

Area 10 to be defined may be shifted or shaped on the map detail by suitable operation of the operating elements of input unit 5, such as the turn-press controller or a further operating element, such as a further turn-press controller.

In detail, the positioning of the area to be defined may be performed in that after the completed selection of area shape 11, the position of area 10 to be defined is fixed on the map detail via turn-press controller 6. Area 10 to be defined may be vertically and/or horizontally shifted by rotating turn-press controller 6. A change is made between the options of horizontal and vertical adjustment by pressing turn-press controller 6. The termination of this action is confirmed by a button press of input button 7.

In addition to a vertical or horizontal displacement, a rotation of area 10 to be defined around a fixed position on the map detail, such as the position of the user and/or the navigation device, may also be performed, the area shape being able to be pivoted around a previously fixed position or the current position of the user via the turn-press controller. The orientation of area 10 to be defined may be fixed via the turn-press controller or a further turn-press controller. The end of this action may be confirmed by another button press of the input button.

The horizontal or vertical extension of area 10 to be defined may then be changed (stretching or compression of predetermined area 10) via the turn-press controller or a further turn-press controller, it being possible to switch between the setting options for horizontal and vertical extension by pressing the turn-press controller.

The shaping of area 10 to be defined may be terminated by a corresponding confirmation, e.g., via a press of a button.

Upon selection of the polygonal area, the polygon which marks area 10 to be defined may be shaped by selecting a corner point of the polygon by pressing turn-press controller 6. It is possible to jump between desired corner points of the polygon by rotating turn-press controller 6, a marked corner point being shown as the selected corner point on output unit 4 by color, graphically, or by altered brightness. The selected corner point may be selected by pressing turn-press controller 6 and may be shifted in the horizontal, vertical, or other direction by rotation. It is possible to switch between the adjustment directions by pressing the input button or a further operating element.

It may be provided that the steps for shaping and positioning area 10 to be defined on the map detail for definition of the geographic area are executed in any sequence.

After area 10 to be defined is shaped and positioned on the map detail in such a way that the geographic area which is of interest to the user is selected, categories for points of interest may be selected. For example, by selecting category symbols 14 in a right section 13 of the display screen, the user may select the categories “restaurant” 15, “hotel” 16, “rest stop” 17, or “gas station” 18, for example, which are to be displayed in the area defined above. The user may select one or more desired category symbols 14 via a menu guide. This may be performed by operating the turn-press controller or a further turn-press controller. The selection of the categories is ended by operating the input button again. Furthermore, the selection of the categories may be performed by selecting checkboxes or by tapping a corresponding term in a list.

Further possibilities may be provided for the input of the categories to be selected, such as an input of the categories as text.

By confirming the category selection, e.g., by pressing on input button 6, processing unit 2 generates a data query and ascertains the POI information coming into consideration in data memory 3. Thus, with the aid of a suitable filter, the POIs in defined (selected) area 10 and corresponding to the selected categories are retrieved from memory 3, depending on defined area 10 on the map detail and depending on the selected categories. The retrieved POIs are displayed by suitable symbols on the display screen of output unit 4. The symbols may specify the particular categories of the POIs.

According to a further example embodiment, output unit 4 and input unit 5 are designed as a touch-sensitive display screen (touchscreen). Elements having an identical or comparable function are provided with identical reference numerals.

If a touch-sensitive display screen is used, the selection of the area shape described above may only be performed by tapping or by tapping on the desired area shape and drawing to a desired position on the map detail. This is shown in FIG. 3, for example. The position of the finger indicates the position of the finger of the user on the display screen. Furthermore, a displacement of area 10 to be defined on the map detail may be performed in that the interior of area 10 to be defined is touched with a finger and the finger is subsequently guided along the surface of the display screen to a position which is desired for the area to be selected on the map detail. The represented area shape moves along under the finger during the movement of the finger on the surface of the display screen.

A change of the area shape and an enlargement or shrinking may be performed in that the user taps an edge section or a corner section (or predefined section) of area 10 to be defined using his finger and draws the finger along the surface of the touchscreen, to thus achieve a corresponding change of the outline of area 10 to be defined. Thus, in the event of prior selection of a polygonal shape as the area shape, the polygon may already be provided with a number of corner sections. Change of the rectangular area shape and the elliptical area shape may thus be performed along their central axes.

Alternatively, if a touchscreen is used, category symbols 14 may be situated on the display screen of output unit 4, which the user may select by tapping with the finger and by drawing along the display screen surface in defined area 10. Alternatively, a selection may be performed by simply tapping on the category symbol. Another tap on a category symbol 14 which is already selected removes the corresponding category from the selection.

According to a further example embodiment, a simplified navigation device may be provided, which does not allow definition of the geographic area, the categorization of the points of interest being able to be performed in the way described above, however. The geographic area is then defined automatically, for example, in the form of a corridor around an ascertained route or around the location in a defined or predefinable vicinity.

The geographic area selected according to the above procedure may be used in connection with the navigation functions for the free definition of an area to be avoided in the navigation, i.e., the defined geographic area is to be excluded from the route guiding. Alternatively, the area selected according to the above method may be preferentially considered in the route ascertainment.

What is claimed is:

1. A method for defining a geographic area in a map detail for use in a navigation device, comprising:
selecting an area shape;
positioning the selected area shape on the map detail at a desired position; and
performing a function of the navigation device depending on a geographic area which is determined by the area shape positioned on the map detail.

2. The method as recited in claim 1, wherein the selected area shape is selected from multiple area shape options including a rectangular area, an elliptical area, and a polygonal area.

3. The method as recited in claim 2, wherein the area shape positioned on the map detail is changed, the change including one of compression, rotation, pivoting, or distortion.

4. The method as recited in claim 3, wherein at least one of the selecting of the area shape, the positioning of the selected area shape, and the changing of the area shape is performed by operating a turn-press controller of the navigation device.

5. The method as recited in claim 3, wherein at least one of the selecting of the area shape, the positioning of the selected area shape, and the changing of the area shape is performed by operating a touch-sensitive display screen of the navigation device, the operation including at least one of tapping on a specific position on the display screen and drawing along a surface of the display screen.

6. The method as recited in claim 3, wherein multiple category symbols are displayed for selection among different categories of points of interest displayable on the map detail, points of interest to be displayed being ascertained as a function of the positioned area shape and at least one selected category, and a symbol for representing the point of interest to be displayed being displayed on the map detail at a position defined by the position information assigned to the point of interest.

7. The method as recited in claim 3, wherein the performed function of the navigation device is an ascertainment of a route in the geographic area defined by the positioned area shape.

8. A navigation device for defining a geographic area in a map detail, comprising:
an output unit configured to display the map detail;
an input unit configured to enable input of at least control command into the navigation device;
a data memory configured to store map information; and
a processing unit configured to control positioning of an area shape selected via the input unit on the map detail at a desired position, wherein a function of the navigation device is executed depending on a geographic area specified by the area shape positioned on the map detail.

9. The navigation device as recited in claim 8, wherein the data memory is configured to store information about points of interest, and wherein the processing unit is configured to: a) display multiple category symbols for selection of different categories of points of interest displayable on the map detail on the output unit; b) ascertain at least one point of interest to be displayed; and c) display a symbol to represent the point of interest to be displayed on the map detail at a position defined by the position information assigned to the point of interest as a function of the positioned area shape and at least one selected category.

10. A computer-readable storage medium storing a computer program including a plurality of computer-executable codes which control, when executed on a computer, a method for defining a geographic area in a map detail for use in a navigation device, the method comprising:
selecting an area shape;
positioning the selected area shape on the map detail at a desired position;
performing a function of the navigation device depending on a geographic area which is determined by the area shape positioned on the map detail;
wherein multiple category symbols are displayed for selection among different categories of points of interest displayable on the map detail, points of interest to be displayed being ascertained as a function of the positioned area shape and at least one selected category, and a symbol for representing the point of interest to be displayed being displayed on the map detail at a position defined by the position information assigned to the point of interest.
